(19) United States
(12) Patent Application Publication
(10) Pub. No.: US 2009/0081980 A1
(43) Pub. Date: Mar. 26, 2009

(54) APPARATUS, SYSTEMS, AND METHODS FOR SUPPRESSING RADIO INTERFERENCE FROM A NOISE SOURCE VIA ACTIVE FILTERING

(75) Inventor: VIPUL M. PATEL, NORTHVILLE, MI (US)

Correspondence Address: INGRASSIA FISHER & LORENZ, P.C. (GM), 7010 E. COCHISE ROAD, SCOTTSDALE, AZ, 85253, US

(73) Assignee: GM GLOBAL TECHNOLOGY OPERATIONS, INC., DETROIT, MI (US)

(21) Appl. No.: 11/860,352

(22) Filed: Sep. 24, 2007

(51) Int. Cl. H04B 1/10; H04B 1/06

(52) U.S. Cl. 455/297; 381/104; 455/296; 455/299; 455/345

(57) ABSTRACT

Apparatus, systems, and methods are provided for suppressing radio interference from a noise source. One apparatus includes a controller for commanding a noise source to dither its operating frequency, and a filter for receiving signals from the controller indicating the present operating frequency of the noise source and to filter radio signals having the same frequency as the present operating frequency while the operating frequency is dithered. A system includes an electric motor having an operating frequency, a controller for commanding the motor to dither its operating frequency, and a filter configured to receive signals indicating the present operating frequency of the motor and to filter radio signals having the same frequency as the present operating frequency while the operating frequency is dithered. One method includes dithering the operating frequency of a noise source and filtering signals having the same frequency as the operating frequency while it is dithered.

### TECHNICAL FIELD

The present invention generally relates to radios, and more particularly relates to actively filtering noise source interference from motor vehicle radios.

### BACKGROUND OF THE INVENTION

Many motor vehicles employ switching power supplies that utilize pulse width modulation to convert the stock vehicle voltage (usually 12 volts) from the vehicle power supply to whatever particular voltage levels are required to run the various electronic modules connected to the power supplies. The switching power supplies operate by selectively switching electronic devices ON and OFF at a certain operating frequency to generate a switched voltage. The output voltage from such power supplies is determined by the duty cycle of the switched voltage.

In a hybrid motor vehicle, for example, the switching power supply for the electric motor of the powertrain often operates at low frequencies (e.g., frequencies less than 10 kilohertz (kHz)). These low frequencies are chosen based on considerations such as efficiency of operation, heating, and the like. However, the harmonics (i.e., whole-number multiples of the operating frequencies) generated by the switching power supply may still cause interference with some of the vehicle's electronic modules (e.g., a radio).

The amplitude modulation (AM) band of automotive radios is particularly susceptible to interference from a switching power supply because AM radios have a 10 kHz resolution (i.e., they are calibrated to tune in stations in increments of 10 kHz). Specifically, AM band radio interference is experienced whenever a power supply harmonic is within plus or minus 5 kHz of the tuned frequency of the radio. Because the AM frequency band extends from 520 kHz to 1710 kHz in 10 kHz increments, the harmonics of a switching power supply operating at a low frequency may cause interference at certain AM band frequencies. For example, a switching power supply operating at 6 kHz may cause interference at 600 kHz (i.e., the power supply's hundredth harmonic), 900 kHz (i.e., the one hundred fiftieth harmonic), 1100 kHz (i.e., the two hundredth harmonic), and so forth.

Accordingly, it is desirable to provide apparatus, systems, and methods for suppressing radio band interference that overcomes the interference problems attendant with conventional motor vehicle radios. Furthermore, other desirable features and characteristics of the present invention will become apparent from the subsequent detailed description and the appended claims, taken in conjunction with the accompanying drawings and the foregoing technical field and background.

### SUMMARY OF THE INVENTION

An apparatus having reduced interference from a noise source including an operating frequency is provided. One apparatus comprises a controller configured to be coupled to the noise source and to command the noise source to dither its operating frequency. The apparatus also comprises a filter coupled to the controller and adapted to receive radio signals. The filter is configured to receive signals from the controller indicating the present operating frequency of the noise source and configured to filter radio signals having the same frequency as the present operating frequency while the operating frequency is dithered.

Systems for suppressing AM band radio interference in a motor vehicle are also provided. A system comprises an electric motor having an operating frequency and a controller coupled to the electric motor and configured to command the electric motor to dither its operating frequency. The system also comprises a filter coupled to the controller. The filter is configured to receive signals from the controller indicating the present operating frequency of the electric motor and configured to filter radio signals having the same frequency as the present operating frequency while the operating frequency is dithered.

A method is provided for suppressing interference from a noise source having a plurality of operating frequencies in a radio comprising a digital filter. One method comprises the steps of dithering the operating frequency of the noise source, and filtering signals having the same frequency as the operating frequency while the operating frequency is dithered.

### DESCRIPTION OF THE DRAWINGS

The present invention will hereinafter be described in conjunction with the following drawing figures, wherein like numerals denote like elements, and

FIG. 1 is a block diagram of one exemplary embodiment of a system for suppressing radio interference from a noise source;

FIG. 2 is schematic diagram of the system of FIG. 1 implemented in an exemplary motor vehicle; and

FIG. 3 is a flow diagram of one exemplary embodiment of a method for suppressing radio interference from a noise source.

### DESCRIPTION OF AN EXEMPLARY EMBODIMENT

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

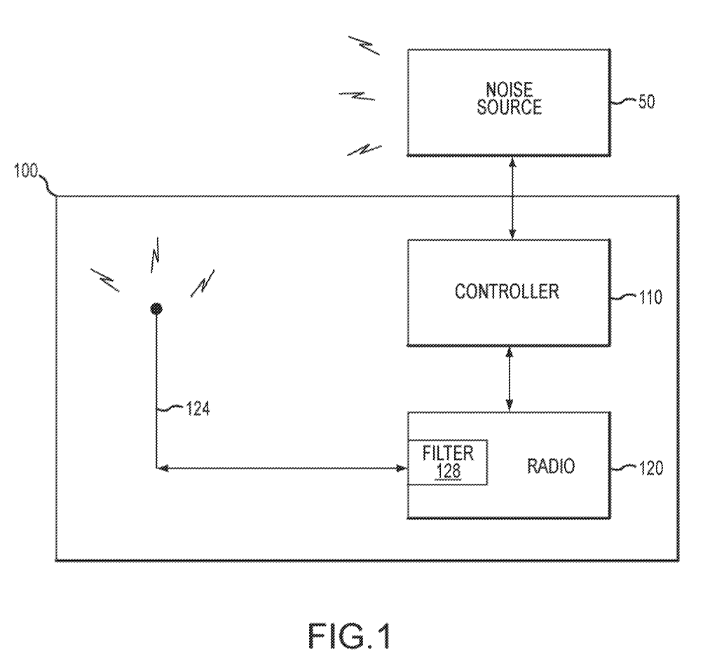

FIG. 1 is a block diagram of one exemplary embodiment of a system 100 for suppressing radio interference from a noise source 50. System 100 comprises a controller 110 capable of being coupled to noise source 50, and a radio 120 comprising a filter 128 coupled to controller 110.

Controller 110 may be any device, hardware, and/or software configured to command noise source 50 to operate at a particular frequency. Controller 110 is also configured to dither the operating frequency of noise source 50 such that noise source 50 operates at a plurality of operating frequencies. For example, if noise source 50 typically operates a 5 kHz, controller 110 is configured to command noise source 50 to operate at various frequencies within plus or minus 1 kHz of its typical operating frequency, although other frequency ranges are contemplated. Specifically, controller 110 may dither the operating frequency of noise source 50 so that noise source 50 operates at, for example, 5.0 kHz, 5.5 kHz, 4.3 kHz, 6.0 kHz, etc. during a particular period of time.

In accordance with one exemplary embodiment of the invention, controller 110 randomly dithers the operating frequency of noise source 50. That is, controller 110 commands noise source 50 to randomly operate at various frequencies between, for example, 4.0 kHz and 6.0 kHz. In another exemplary embodiment, controller 110 dithers the operating frequency of noise source 50 in a repeated pattern. For example, controller 110 may command noise source to repeatedly operate at frequencies of 4.0 kHz, 5.0 kHz, and 6.0 kHz during a particular period of time. That is, the 4.0 kHz, 5.0 kHz, and 6.0 kHz is continually repeated throughout the time period.

Controller 110 is also configured to transmit the various operating frequencies of noise source 50 to radio 120 as controller 110 commands noise source 50 to do such. Specifically, while controller 110 is dithering the operating frequency of noise source 50, controller 110 is also transmitting each of the dithered frequencies to radio 120.

Radio 120 may be any device, hardware, and/or software capable of receiving and demodulating radio signals. In one embodiment, radio 120 may be an amplitude modulated (AM) radio.

Radio 120 comprises an antenna 124 for receiving signals and a re-configurable filter 128. Filter 128 may be any device, hardware, and/or software configurable to filter a range of signals having a plurality of frequencies. That is, filter 128 is a filter capable of being re-configured to filter signals having a variety of frequencies. In accordance with one exemplary embodiment of the invention, filter 128 is a digital filter configured to filter signals audible to a human (e.g., signals having a frequency of about 20 Hz to about 20 kHz). For example, filter 128 may be an intermediate frequency digital signal processor (I/F DSP), a comb filter, a notch filter, and the like filter.

During operation, as radio 120 is notified by controller 110 of the various operating frequencies of noise source 50 due to dithering, filter 128 is re-configured to filter signals having the same frequency as noise source 50. Specifically, filter 128 is re-configurable to filter signals having frequencies that match the current operating frequency of noise source 50. That is, filter 128 changes the signals it filters based on the current operating frequency of noise source 50. For example, if noise source 50 is dithered by controller 110 to operate at 5.0 kHz, 5.5 kHz, 4.3 kHz, 6.0 kHz, etc. over a period of time, filter 128 will likewise filter received signals having frequencies of 5.0 kHz, 5.5 kHz, 4.3 kHz, 6.0 kHz, etc., respectively, during each corresponding period of time.

Filter 128 is also configured to determine if one or more of the harmonics of the operating frequency of noise source 50 are less than about 10 kHz. Filter 128 is also configured to filter both signals having the same frequency as the current operating frequency of noise source 50 and signals having the same frequency as a harmonics of the operating frequency when one or more of the harmonics of the operating frequency less than about 10.0 kHz or within the audible range of a human. For example, if noise source 50 is commanded to dither its operating frequency at 2.0 kHz, 2.5 kHz, and 3.0 kHz, filter 128 recognizes that the 2.0 kHz signal has harmonics at 4.0 kHz, 6.0 kHz, 8.0 kHz, and 10.0 kHz. Filter 128 will also recognize that the 2.5 kHz signal has harmonics at 5.0 kHz, 7.5 kHz, and 10.0 kHz, and the 3.0 kHz signal has harmonics at 6.0 kHz and 9.0 kHz. As a result, filter 128 will filter signals having a frequency of 2.0 kHz, 2.5 kHz, 3.0 kHz, 5.0 kHz, 6.0 kHz, 7.5 kHz, 9.0 kHz, and 10.0 kHz.

By dithering the operating frequency of noise source 50 and having filter 128 filter signals having a frequency corresponding to the operating frequency of noise source 50 and harmonics of the operating frequency that are less than about 10.0 kHz, signals received by radio 120, and harmonics of these signals, that would otherwise cause interference in radio 120 are not allowed to pass. Furthermore, because the filtered frequency (and harmonics) of signals changes due to dithering, users of radio 120 are substantially unable to detect that various tones in desired signals that correspond to a particular frequency are being filtered.

For example, if noise source 50 maintained a constant 4.0 kHz operating frequency and filter 128 only filtered signals having a frequency of 4.0 kHz, signals demodulated by radio 120 would exclude tones corresponding to 4.0 kHz. The continual exclusion of particular tones corresponding to 4.0 kHz from some broadcasts (e.g., music, human speech, etc.) may be noticeable by users and these broadcasts may seem odd and/or may annoy some users of a radio. In addition, if filter 128 did not also filter harmonics having a frequency less than about 10.0 kHz and/or within the audible range of a human, radio 120 would still experience interference from the second harmonic of 8.0 kHz, the third harmonic of 12.0 kHz, the fourth harmonic of 16.0 kHz, and/or the fifth harmonic of 20.0 kHz.

With this said, various embodiments of the invention do contemplate that controller 110 is configured to command noise source 50 to maintain a substantially constant operating frequency and filter 128 is configured to filter signals having the same frequency as the operating frequency of noise source 50. That is, the operating frequency of noise source 50 may not be dithered, but signals having the same frequency as noise source 50 would be filtered. Furthermore, various embodiments of the invention do contemplate that controller 110 is configured to command noise source 50 to maintain a substantially constant operating frequency and filter 128 is configured to filter signals having the same frequency as the operating frequency of noise source 50 as well as any harmonics that are less than about 10.0 kHz. Specifically, the operating frequency of noise source 50 may not be dithered, but signals having the same frequency as noise source 50 and signals having a frequency of less than about 10.0 kHz that is the same frequency as a harmonic of the operating frequency would be filtered.

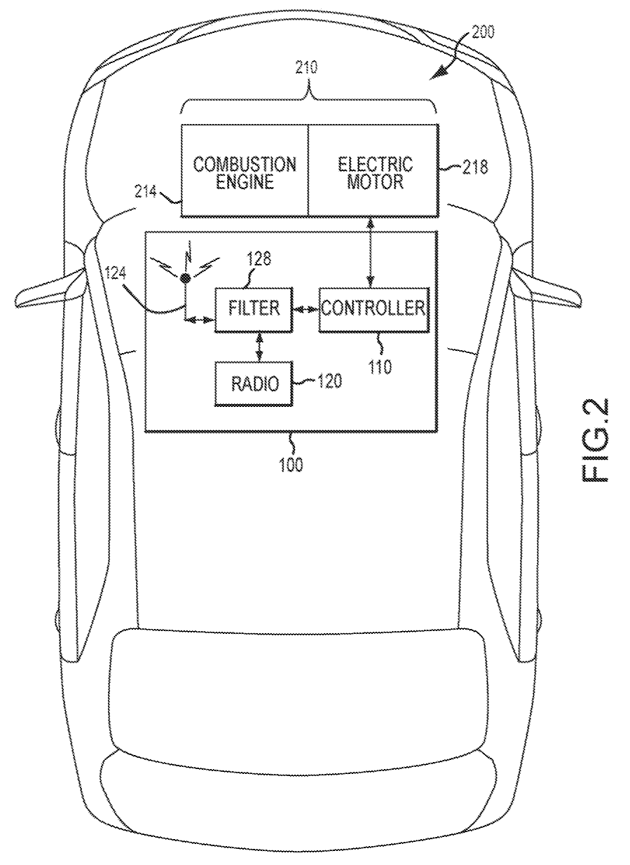

FIG. 2 is a schematic diagram of system 100 implemented in a motor vehicle 200 comprising a powertrain 210. As illustrated, powertrain 210 is a hybrid motor comprised of a combustion engine 214 and an electric motor 218, although powertrain 210 may only include electric motor 218 or another type of noise-generating motor.

In motor vehicle 200, powertrain 210, and particularly electric motor 218, is a noise source similar to noise source 50 in FIG. 1. Accordingly, controller 110 dithers the operating frequency of powertrain 210 (i.e., electric motor 218) and communicates the various operating frequencies of electric motor 218 to radio 120 so that filter 128 can filter signals received by radio 120 (via antenna 124) having the same frequency as the current operating frequency of electric motor 218. Specifically, as the operating frequency of electric motor 218 changes (i.e., is dithered), filter 128 likewise changes the frequencies of signals it filters.

As illustrated in FIG. 2, filter 128 may be external to radio 120. That is, filter 128 may be part of radio 120 (see FIG. 1), or may be a separate component (see FIG. 2). In either configuration, filter 128 is in communication with controller 110, antenna 124, and radio 120.

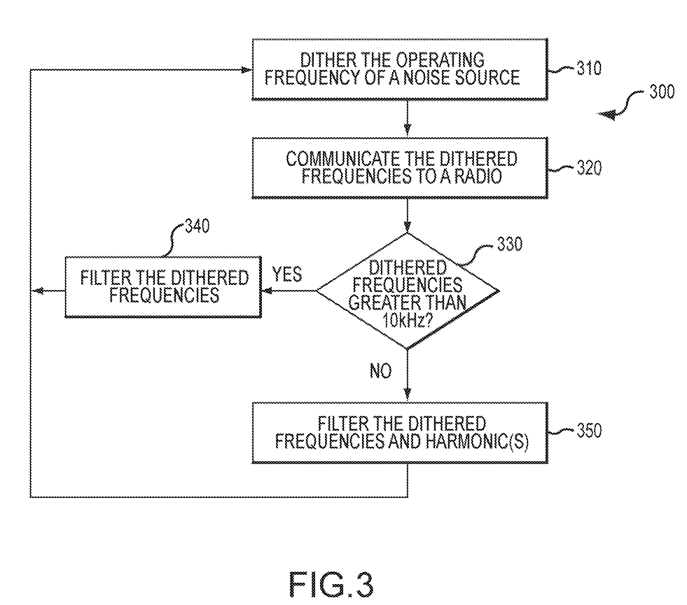

FIG. 3 is a flow diagram of one exemplary embodiment of a method 300 for suppressing interference from a noise source (e.g., noise source 50, powertrain 210, electric motor 218, and the like). Method 300 begins by dithering the operating frequency of the noise source (step 310) via a controller (e.g., controller 110). In one embodiment, the operating frequency is less than about 10.0 kHz and the controller may dither the operating frequency of the noise source in a repeating pattern or may dither the operating frequency randomly.

The various operating frequencies of the noise source are communicated to a radio (e.g., radio 120) as the operating frequency of the noise source is being dithered (i.e., changed) (step 320). The radio 120 then determines if the various operating frequencies are greater than 10.0 kHz (step 330).

If an operating frequency is greater than 10.0 kHz, the radio filters signals having the same frequency as the operating frequency via, for example, a filter (e.g., filter 128) (step 340). If an operating frequency is less than 10.0 kHz, the radio filters signals having the same frequency as the operating frequency and signals having the same frequency as the harmonic(s) of the operating frequency that are less than 10.0 kHz and/or are within the audible range of a human (step 350).

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

I claim:

1. A radio having reduced interference from a noise source including an operating frequency, comprising:
a controller configured to be coupled to the noise source and to command the noise source to dither the operating frequency; and
a filter coupled to the controller and adapted to receive radio signals, the filter configured to receive signals from the controller indicating a present operating frequency of the noise source and to filter radio signals having the same frequency as the present operating frequency while the operating frequency is dithered.

2. The radio of claim 1, wherein the radio comprises a digital filter configured to filter the radio signals having the same frequency as the present operating frequency as the operating frequency is dithered.

3. The radio of claim 1, wherein the filter is further configured to filter signals having the same frequency as a harmonic of the present operating frequency.

4. The radio of claim 1, wherein the radio comprises a digital signal processor to filter the radio signals having the same frequency as the present operating frequency as the operating frequency is dithered.

5. The radio of claim 1, wherein the controller is further configured to command the noise source to randomly dither the operating frequency.

6. The radio of claim 1, wherein the controller is further configured to command the noise source to dither the operating frequency in a pre-determined pattern.

7. The radio of claim 1, wherein the operating frequency is less than 10 kHz.

8. The radio of claim 7, wherein each of the dithered operating frequencies is less than 1 kHz from the operating frequency.

9. A system for suppressing radio interference in a motor vehicle, comprising:
an electric motor having an operating frequency;
a controller coupled to the electric motor and configured to command the electric motor to dither the operating frequency; and
a filter coupled to the controller, the filter configured to receive signals from the controller indicating a present operating frequency of the electric motor and to filter radio signals having the same frequency as the present operating frequency while the operating frequency is dithered.

10. The system of claim 9, wherein the radio comprises a digital filter for filtering the received signals having the same frequency as the present operating frequency as the operating frequency is dithered.

11. The system of claim 9, wherein the radio comprises a digital signal processor for filtering the received signals having the same frequency as the present operating frequency as the operating frequency is dithered.

12. The system of claim 9, wherein the filter is further configured to filter signals having the same frequency as a harmonic of the present operating frequency.

13. The system of claim 9, wherein the radio comprises a notch filter for filtering the received signals having the same frequency as the present operating frequency as the operating frequency is dithered.

14. The system of claim 9, wherein the electric motor is a powertrain motor.

15. The radio of claim 9, wherein the controller is further configured to command the electric motor to randomly dither the operating frequency.

16. The radio of claim 9, wherein the controller is further configured to command the electric motor to dither the operating frequency in a pre-determined pattern.

17. A method for suppressing interference from a noise source having an operating frequency in a radio comprising a digital filter, comprising the steps of:
dithering the operating frequency of the noise source; and
filtering signals having the same frequency as the operating frequency while the operating frequency is dithered.

18. The method of claim 17, further comprising the step of communicating the operating frequency to the radio as the operating frequency is dithered.

19. The method of claim 17, wherein the dithering step comprises one of randomly dithering the operating frequency and dithering the operating frequency in a pre-determined pattern.

20. The method of claim 17, further comprising the step of filtering signals having the same frequency as a harmonic of the operating frequency.
